(19) United States
(12) Patent Application Publication
(10) Pub. No.: US 2016/0000264 A1
(43) Pub. Date: Jan. 7, 2016

(54) DEVICE FOR ACCELERATING THE IGNITION OF CHARCOALS IN A CHARCOAL STARTER

(71) Applicant: PADAMO DENMARK APS, Aarslev (DK)

(72) Inventors: Morten KRISTENSEN, Aarslev (DK); Daniel PEDERSEN, Odense C (DK); Patrick THOMSEN, Odense C (DK)

(21) Appl. No.: 14/769,858

(22) PCT Filed: Feb. 6, 2014
(86) PCT No.: PCT/DK2014/050031

§ 371 Date: Aug. 24, 2015

(30) Foreign Application Priority Data
Feb. 25, 2013 (DK) PA 2013 70102

(51) Int. Cl. A47J 37/07; F23Q 7/04

(52) U.S. Cl. CPC A47J 37/079; F23Q 7/04

(57) ABSTRACT

A device for accelerating the ignition of charcoals in a charcoal starter, the device comprising a housing with a roof enclosing an air delivery means for delivering an airflow through the roof, the roof having a centrally positioned cone-shaped perforated portion through which the airflow can escape the housing, said roof being able to support the lower part of the charcoal starter, the device further comprising a tray for placing solid burning fuel, the tray having a hole fitting the cone-shaped perforated portion.

### FIELD OF THE INVENTION

The present invention relates to a device for accelerating the ignition of charcoals in a charcoal starter, preferably a cylindrical charcoal starter.

### BACKGROUND OF THE INVENTION

Charcoal fuelled grills, which have not materially changed for several decades, are generally considered to be very slow to ignite and make ready for barbequing. The prior art has attempted to make charcoal ignition more convenient. Charcoal starters are known which ignite charcoal briquettes prior to their insertion into the grill. These devices typically are open cylinders which heat the charcoal from below. Once the charcoal is heated, it can be deposited into the grill by pouring the briquettes from the open top end of the cylinder. An advantage to this type of charcoal starting device is that it allows one batch of charcoal to be started while the grill is being used by a previous batch of charcoal. However, since this device also takes considerable time to ignite charcoal, a second batch of charcoal must be started well in advance of the time it is to be placed in the grill. As a result, charcoal may be wasted by starting batches that may not be needed by the time the charcoal is ready to use.

There appears to have been no serious efforts to solve the long-standing real problems that could have helped to ensure the viability of charcoal as a fuel. Meaningful efforts have been virtually restricted to reducing the time required to fully ignite a bed of charcoal with a small fan, however, such fan solutions have so far not been very useful due to the heterogeneous ignition of charcoals placed in the upper and lower parts of the charcoal starter. Moreover, in charcoal starters using ignition briquettes (e.g. gel-based or similar) to accelerate the ignition of the charcoal the igniting flames are not sufficiently well-distributed within the charcoal starter. As an example thereof EP 2301398 A2 discloses a device for accelerating the ignition of charcoals in a charcoal starter, where the device comprises a house with a flat roof having a centrally positioned arc-shaped perforated portion, through which airflow can escape and a cup for liquid fuel disposed under the arc-shaped perforated portion. This device provides a too slow and heterogeneous ignition of charcoals placed in a charcoal starter.

Hence, the present invention aims to overcome these problems by providing a solution for obtaining homogeneously ignited charcoals in common cylindrical charcoal starters, such as those sold by the company Weber (e.g. U.S. Pat. No. 5,469,835).

### SUMMARY OF THE INVENTION

Accordingly the present invention is directed to a device for igniting charcoals in a charcoal starter by using forced air. The device is used to prepare, or start, charcoal and/or other wood-based fuels for use in a barbeque or similar structure for cooking food.

The device includes a housing enclosing air delivery means for delivering an air flow. The device is configured to receive cylindrical charcoal starters.

The present invention provides a device for accelerating the ignition of charcoals in a charcoal starter, preferably a cylindrical charcoal starter, said device comprising:
a housing with a roof, preferably a flat roof, enclosing air delivery means for delivering an upwardly directed airflow through the roof, said flat roof having a centrally positioned cone-shaped perforated portion through which the airflow can escape the housing, said roof being able to receive the lower part of the charcoal starter; and
a tray, preferably a fixed or detachable disc-shaped tray, for placing solid burning fuel, said tray having a hole fitting the cone-shaped perforated portion.

In a preferred embodiment of the invention the housing is a vertically disposed cylindrical wall with perforations for inlet air.

Preferably the cone-shaped portion protrudes 2-10 cm above the flat part of the roof. Also preferred is that the cone-shaped portion has a diameter in its lower part of 3-10 cm. Moreover, it is preferred that the cone-shaped portion has a diameter in its upper part of 1-6 cm. Similarly it is preferred that the cone-shaped portion forms an angle with the flat part of the roof of 25-85 degrees, preferably 60-85 degrees.

The air delivery means may include a fan, blower, or compressor, and in some embodiments, the air delivery mechanism is a battery-powered air delivery mechanism.

### BRIEF DESCRIPTION OF THE DRAWINGS

FIG. 1 is a side elevation view of the device according to the present invention.

FIG. 2 is a partial cross-sectional, partial fragmentary view of the device of FIG. 1.

### DETAILED DESCRIPTION OF THE INVENTION

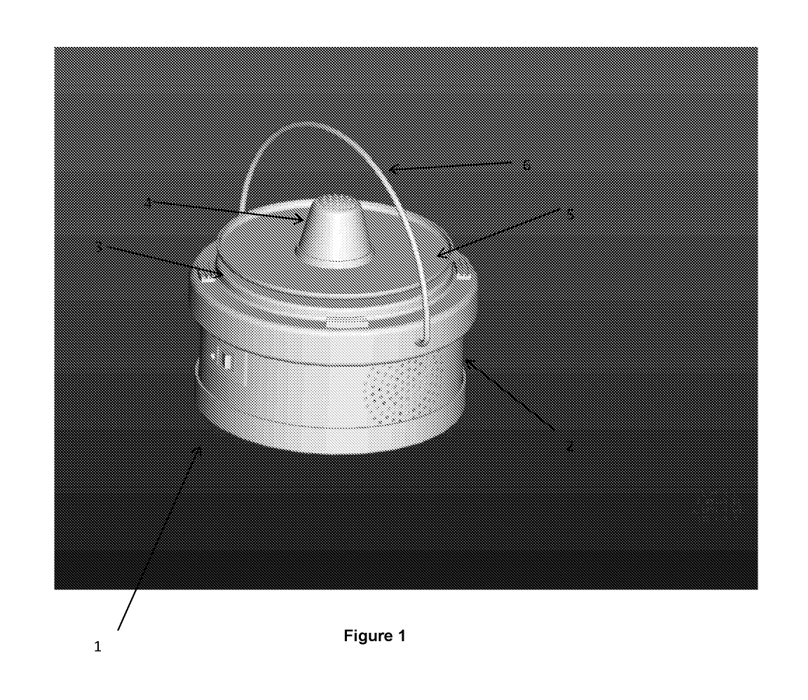

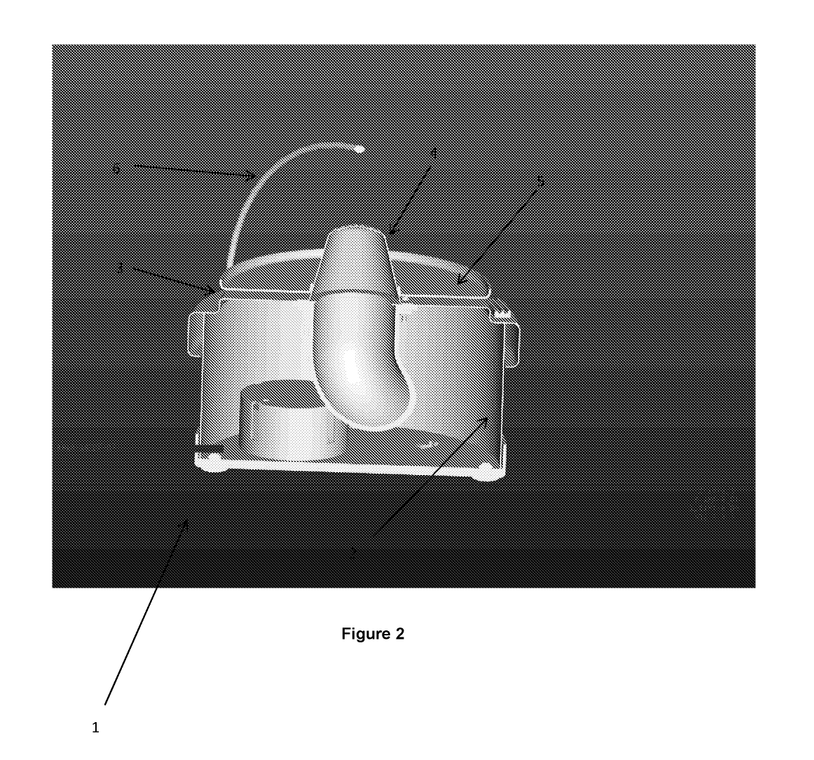

An illustrative, non-exclusive example of the device according to the present disclosure is shown in FIGS. 1 and 2. The device 1 is designed to prepare charcoal, wood, or other combustible fuels for use in barbequing food.

The device 1 is designed to “start” charcoal, wood, or a similar barbequing fuel prior to the fuel's use to cook food, typically after removal of the fuel from the igniter and placement of the fuel in a barbeque or similar structure for cooking food.

As appears from FIGS. 1 and 2, the device 1 has a housing 2 with a roof 3 enclosing air delivery means for delivering an upwardly directed airflow through a centrally positioned cone-shaped perforated portion 4 through which the airflow can escape the housing 2. A tray 5 with a central hole is placed on the cone-shaped portion 4. Importantly, the present inventors have found that the tray in combination with the cone-shaped portion result in a very efficient and even ignition of the charcoals; within a few minutes the charcoals are ready for cooking.

The flow of air is a forced-air flow, as the air delivery means forces the flow of air through the cone-shaped perforated portion and thereby focuses the air flow into the central part of the charcoal starter. The inventors have surprisingly found that this air-flow efficiently provides air (oxygen) to the flame generated by the solid burning fuel (such as petroleum based fuel) placed in the tray 5.

The handle 6 is useful when the user desires to move the device from place to place.

1. A device for accelerating the ignition of charcoals in a charcoal starter, preferably a cylindrical charcoal starter, said device comprising:
a housing with a roof, preferably a flat roof, enclosing air delivery means for delivering an upwardly directed airflow through the roof, said flat roof having a centrally positioned cone-shaped perforated portion through which the airflow can escape the housing, said roof being able to receive the lower part of the charcoal starter; and
a tray, preferably a fixed or detachable disc-shaped tray, for placing solid burning fuel, said tray having a hole fitting the cone-shaped perforated portion.

2. The device according to claim 1, wherein the housing is a vertically disposed cylindrical wall with perforations for inlet air.

3. The device 1 according to claim 1, wherein the cone-shaped portion protrudes 2-10 cm above the flat part of the roof.

4. The device 1 according to claim 1, wherein the cone-shaped portion has a diameter in its lower part of 3-10 cm.

5. The device according to claim 1, wherein the cone-shaped portion has a diameter in its upper part of 1-6 cm.

6. The device according to claim 1, wherein the cone-shaped portion 4 forms an angle with the flat part of the roof of 25-85 degrees, preferably 60-85 degrees.

7. The device according to claim 1, wherein the air delivery means includes a fan, blower, or compressor, and in some embodiments, the air delivery mechanism is a battery-powered air delivery mechanism.

8. The device according to claim 1, wherein the device is provided with a handle for easy carrying of the device.

9. The device according to claim 1, wherein the tray is 1-9 cm, preferably 2-5 cm, above the flat part of the roof.
